(19) United States
(12) Patent Application Publication
(10) Pub. No.: US 2026/0302395 A1
(43) Pub. Date: Oct. 1, 2026

(54) SELF-MAINTAINED LEAD ACID BATTERY SYSTEM AND METHOD

(71) Applicant: Saudi Arabian Oil Company, DHAHRAN (SA)

(72) Inventors: Abdullah Y. Al-Hassan, Dhahran (SA); Ahmed M. Salamah, Yanbu (SA); Thamer M. Baggazi, Yanbu (SA); Ibrahim A. AlQarni, Yanbu (SA)

(73) Assignee: Saudi Arabian Oil Company, DHAHRAN (SA)

(21) Appl. No.: 19/089,376

(22) Filed: Mar. 25, 2025

(51) Int. Cl. H01M 10/48; H01M 10/08; H01M 10/42; H01M 50/609

(52) U.S. Cl. CPC H01M 10/484; H01M 10/4228; H01M 10/482; H01M 10/488; H01M 50/609; H01M 10/08

(57) ABSTRACT

Integrated battery systems and methods are provided that improve safety and maintenance efficiency and efficacy. The integrated battery systems and methods herein include electrolyte management functionality and operations for monitoring electrolyte and maintaining electrolyte in individual batteries in a battery bank, including multi-function refilling with filling of plural cells while also sensing other aspects including water leakage, electrolyte level sensing, advance and early sensing of leakages to identify and correct issues to prevent and/or minimize damage, and also monitoring the entire bank, all of which are described in more detail herein. In the event of abnormalities one or more proactive responses are undertaken to correct issues to prevent and/or minimize damage and/or push notifications for advanced diagnostics.

### FIELD OF THE DISCLOSURE

The present invention relates to lead acid battery banks and management thereof.

### BACKGROUND OF THE DISCLOSURE

Lead acid battery banks are used in applications that require reliable backup power and other uses. The battery banks are typically situated in dedicated rooms or groups of rooms referred to as battery installations. The individual lead-acid batteries use sulfuric acid as electrolyte introduced during a commissioning stage of the battery(ies). The liquid levels of individual or plural batteries may reduce after charging and discharging cycles, and as a result typical battery installations include a maintenance schedule including manual checking and filling, if necessary, of each individual battery, for example using a funnel and containers to add a required amount of distilled water. This process is essential as preventive maintenance, for example, on a monthly basis, and more frequently during periods of higher temperature seasons.

The present disclosure addresses the needs for improved maintenance of lead-acid batteries by providing a heretofore unavailable integrated system and method.

### SUMMARY OF THE DISCLOSURE

The disclosure herein is well-positioned to revolutionize maintenance protocols for lead acid batteries by incorporating proactive and reactive electrolyte monitoring, automatic electrolyte filling, real-time leak detection, and maintenance alert activation in a manner that minimizes manual labor and mitigates risks associated with electrolyte flooding, battery drying, and electrolyte leakage in the environment of the lead acid batteries.

In some embodiments, a method for self-maintenance of a battery bank is provided. The battery bank comprises a plurality of lead-acid batteries, wherein each lead-acid battery comprises a jar containing electrolyte comprising sulfuric acid and water, and a pair of connection terminals, wherein the connection terminals of the plurality of batteries are operatively coupled to one another and operatively connected to a load. The method for self-maintenance of said battery bank includes providing a controller having a memory and a processor communicatively coupled to a battery electrolyte maintenance sub-system, the battery electrolyte maintenance sub-system including a battery filling system plug on each battery of the battery bank, a reservoir of water, fluid communication conduits between the reservoir of water and the battery filling system plug on each battery, and a controllable pump between the reservoir of water and the fluid communication conduits. The method for self-maintenance of said battery bank further includes monitoring a surface below the batteries with one or more sensors communicatively coupled to the controller for an electrolyte leak condition, and transmitting to the controller a leak condition signal when fluid is detected on the surface.

The method for self-maintenance of said battery bank includes, for each battery or a designated group of batteries, carrying out a routine of: monitoring an electrolyte level with one or more level sensors associated with the battery and communicatively coupled to the controller, and (a) upon sensing a normal low electrolyte level (“NLEL”) corresponding to an electrolyte level within the battery that is within a predetermined range associated with normal electrolyte loss, transmitting a NLEL signal to the controller, or (b) upon sensing an abnormal low electrolyte level (‘ALEL”) corresponding to an electrolyte level within the battery that is below the predetermined range associated with normal electrolyte loss, transmitting a ALEL signal to the controller; monitoring overflow condition with one or more overflow sensors associated with each battery and communicatively coupled to the controller, and upon sensing an electrolyte overflow condition (“OFC”) corresponding to fluid that is detected outside of the battery from one or more of the battery filling system plugs, transmitting an OFC signal to the controller; and transmitting from the controller instructions to the controllable pump for carrying out responsive filling of the battery or the designated group of batteries with the battery electrolyte maintenance sub-system when (a) the controller receives a NLEL signal, and (b) the controller does not receive any one or more of (i) an ALEL signal, (ii) an OFC signal, or (iii) a leak condition signal.

In some embodiments, the aforementioned method further comprises generating an external indicator that presents a condition of one or more batteries in the battery bank, the conditions including one or more of: presence or absence of a leak condition signal associated with a designated battery corresponding to fluid being detected on the surface; presence or absence of an OFC signal associated with a designated battery corresponding to fluid being detected outside of the battery from one or more of the battery filling system plugs; presence or absence of a NLEL signal associated with a designated battery corresponding to an electrolyte level within the battery that is within the predetermined range associated with normal electrolyte loss; presence or absence of an ALEL signal associated with a designated battery corresponding to an electrolyte level within the battery that is below the predetermined range associated with normal electrolyte loss; or state of responsive filling operations. The external indicator may comprise an increased volume audible alert, a distinctive audible alert, a voice alert, a blinking visual alerts, a text message alert, an icon image message alert, a real-time camera image alert, a voice alert, or a combination of one of the forgoing alerts.

In some embodiments, the aforementioned method further includes a controller that is programmed with scheduled filling instructions, and wherein the method further comprises: transmitting from the controller instructions to the controllable pump for carrying out scheduled filling of the designated battery in the battery bank with the battery electrolyte maintenance sub-system when the controller does not receive any one of (i) an ALEL signal from the designated battery, (ii) an OFC signal from the designated battery, or (iii) a leak condition signal. In some embodiments, scheduled filling operations coincide with one or more charging cycles of the designated battery. In some embodiments, the method further including a controller that is programmed with scheduled filling instructions further comprises: generating an external indicator that presents a condition of one or more batteries in the battery bank, the conditions including one or more of: presence or absence of a leak condition signal associated with a designated battery corresponding to fluid being detected on the surface; presence or absence of an OFC signal associated with a designated battery corresponding to fluid being detected outside of the battery from one or more of the battery filling system plugs; presence or absence of a NLEL signal associated with a designated battery corresponding to an electrolyte level within the battery that is within the predetermined range associated with normal electrolyte loss; presence or absence of an ALEL signal associated with a designated battery corresponding to an electrolyte level within the battery that is below the predetermined range associated with normal electrolyte loss; or state of filling operations and including whether a filling operation is a responsive filling operation or a scheduled filling operation. The external indicator may comprise an increased volume audible alert, a distinctive audible alert, a voice alert, a blinking visual alerts, a text message alert, an icon image message alert, a real-time camera image alert, a voice alert, or a combination of one of the forgoing alerts.

In some embodiments, the aforementioned method further includes, during periods of responsive filling, continued monitoring of the electrolyte level within the designated battery, and wherein responsive filling ends when a predetermined normal electrolyte level is reached.

In some embodiments, the battery electrolyte maintenance sub-system further comprises controllable valves associated with the batteries in the battery bank, and wherein responsive filling includes opening selected controllable valves to open fluid communication between the controllable pump and the battery filling system plug on each battery.

In some embodiments a battery system is provided integrating electrolyte monitoring and maintenance. The system includes a battery bank comprising a plurality of lead-acid batteries, wherein each lead-acid battery comprises a jar containing electrolyte comprising sulfuric acid and water, and a pair of connection terminals, wherein the connection terminals of the plurality of batteries are operatively coupled to one another and operatively connected to a load. The system further includes a battery electrolyte maintenance sub-system including a battery filling system plug on each battery of the battery bank, a reservoir of water, fluid communication conduits between the reservoir of water and the battery filling system plug on each battery, and a controllable pump between the reservoir of water and the fluid communication conduits. The system also includes an external fluid monitoring sub-system including a plurality of leak sensors positioned to detect liquid leakage from one or more battery jars. The system additionally includes an internal battery electrolyte monitoring sub-system including, in each battery, one or more level sensors operable to determine a normal low electrolyte level and an abnormal low electrolyte level. Also provided in the system is an overflow sensor on each battery operable to determine presence of an overflow condition, which can be part of the battery electrolyte maintenance sub-system, the external fluid monitoring sub-system or the internal battery electrolyte monitoring sub-system. The system further includes a controller having a memory and processor that is communicatively connected to the battery electrolyte maintenance sub-system, the external fluid monitoring sub-system, the internal battery electrolyte monitoring sub-system, and the overflow sensor, wherein the controller is programmed to execute processes for: monitoring an electrolyte level with the one or more level sensors associated with each battery and communicatively coupled to the controller, and (a) upon sensing a normal low electrolyte level (“NLEL”) corresponding to an electrolyte level within the battery that is within a predetermined range associated with normal electrolyte loss, transmitting a NLEL signal to the controller, or (b) upon sensing an abnormal low electrolyte level (‘ALEL”) corresponding to an electrolyte level within the battery that is below the predetermined range associated with normal electrolyte loss, transmitting a ALEL signal to the controller; monitoring overflow condition with the one or more overflow sensors associated with each battery and communicatively coupled to the controller; and upon sensing an electrolyte overflow condition (“OFC”) corresponding to fluid that is detected outside of the battery from one or more of the battery filling system plugs, transmitting an OFC signal to the controller; and transmitting from the controller instructions to the controllable pump for carrying out responsive filling of the battery or the designated group of batteries with the battery electrolyte maintenance sub-system when (a) the controller receives a NLEL signal, and (b) the controller does not receive any one or more of (i) an ALEL signal, (ii) an OFC signal, or (iii) a leak condition signal.

In some embodiments the battery filling system plug on each battery comprises a sensor adapted to determine overflow, wherein the overflow sensor on each battery is a redundant sensor.

In some embodiments the one or more level sensors operable to determine a normal low electrolyte level and an abnormal low electrolyte level are internal to the battery jar. In other embodiments the one or more level sensors operable to determine a normal low electrolyte level and an abnormal low electrolyte level are external to the battery jar.

In certain embodiments the batteries are supported on a surface elevated from the ground, and the leak sensors are provided on the elevated surface, on the ground, or on both the ground and the elevated surface.

These and other aspects, features, and advantages can be appreciated from the following description of certain embodiments of the invention and the accompanying drawing figures and claims.

### BRIEF DESCRIPTION OF THE DRAWINGS

FIG. 1A is a schematic block diagram of an exemplary embodiment of a self-maintained battery system including sub-systems for monitoring and managing electrolyte levels according to the present disclosure.

FIG. 1B is an overview of connection of batteries deployed in the self-maintained battery system herein.

FIG. 2 is a schematic top view of an exemplary battery deployed in the self-maintained battery system herein.

FIGS. 3A and 3B are schematic side sectional views exemplary batteries showing embodiments of an internal battery electrolyte monitoring sub-system deployed in the self-maintained battery system herein.

FIG. 4 is a schematic top view of an exemplary battery electrolyte maintenance sub-system deployed in the self-maintained battery system herein.

FIG. 5 depicts an embodiment of a plug used in the self-maintained battery system herein.

FIGS. 6A, 6B and 6C are schematic diagrams of exemplary external fluid monitoring sub-systems deployed in the self-maintained battery system herein.

FIG. 7 is a logical flow diagram of an exemplary embodiment of a method for operation of the self-maintained battery system herein.

FIG. 8 is a block diagram of a computing device deployed in one or more controllers herein.

### DETAILED DESCRIPTION OF CERTAIN EMBODIMENTS OF THE DISCLOSURE

The disclosure herein presents integrated battery systems and methods that improve safety and maintenance efficiency and efficacy. The necessity for reliable backup power such as one or more Uninterruptible Power Supplies (UPS) in complex Information Technology (IT) systems has fostered the widespread use of battery banks, often composed of lead-acid batteries. In embodiments herein, integrated battery systems and methods are provided. In certain embodiments integrated battery systems and methods herein include lead acid batteries and use thereof. The integrated battery systems and methods herein include electrolyte management functionality and operations for monitoring electrolyte and maintaining electrolyte in individual batteries in a battery bank, including multi-function refilling with filling of plural cells while also sensing other aspects including water leakage, electrolyte level sensing, advance and early sensing of leakages to identify and correct issues to prevent and/or minimize damage, and also monitoring the entire bank, all of which are described in more detail herein. In the event of abnormalities one or more proactive responses are undertaken, also which are described in more detail herein.

In certain embodiments integrated battery systems herein are referred to as a self-maintained lead acid battery systems. In certain aspects, the integrated system is a self-maintained lead acid battery system that is an energy storage device of a UPS. In certain aspects, the integrated system is a self-maintained lead acid battery system that is an energy storage device of a UPS for one or more computing devices such as servers, also referred to as an IT battery installation or room. In certain aspects, the integrated system is a self-maintained lead acid battery system that is an energy storage device of an IT battery installation that is situated in remote and hard-to-reach locations. In certain aspects, the integrated system is a self-maintained lead acid battery system that is an energy storage device of an IT battery installation that is situated in remote and hard-to-reach locations and that includes recharging with photovoltaic cells. In such remote battery installations, a field team or other operators cannot respond in a timely manner to manage electrolyte levels of individual batteries. In certain aspects, the integrated system is a self-maintained lead acid battery system that is suitable for warmer seasons; for example, excessive water loss occurs by up to 35-50% more in the summer season as compared to the winter season.

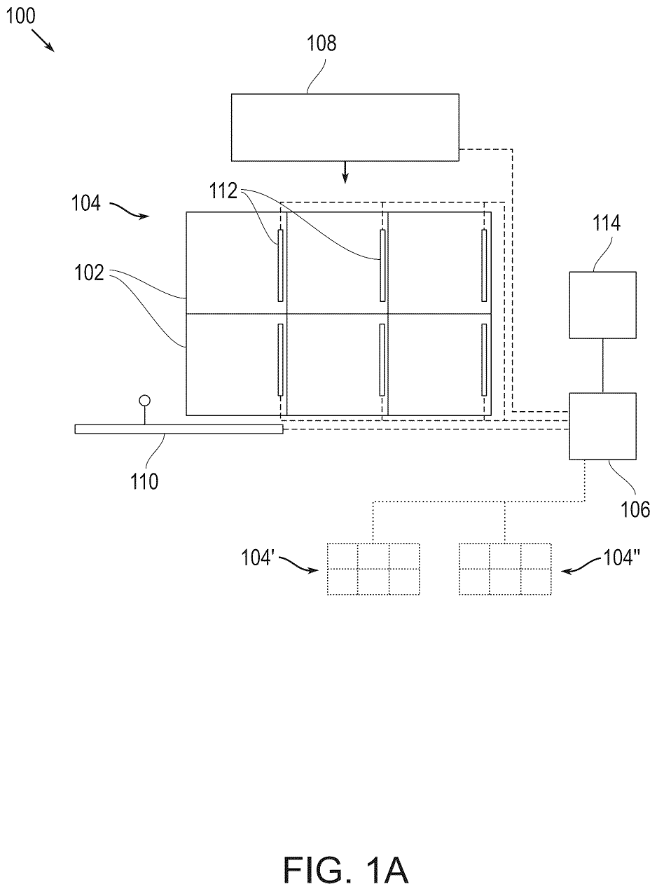

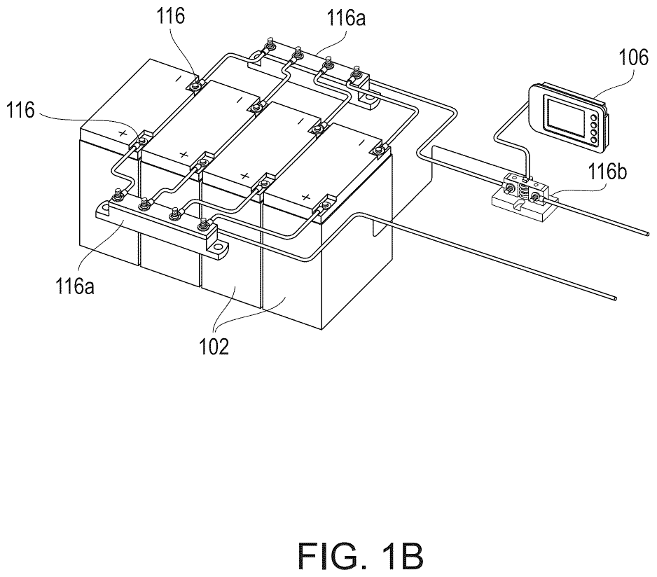

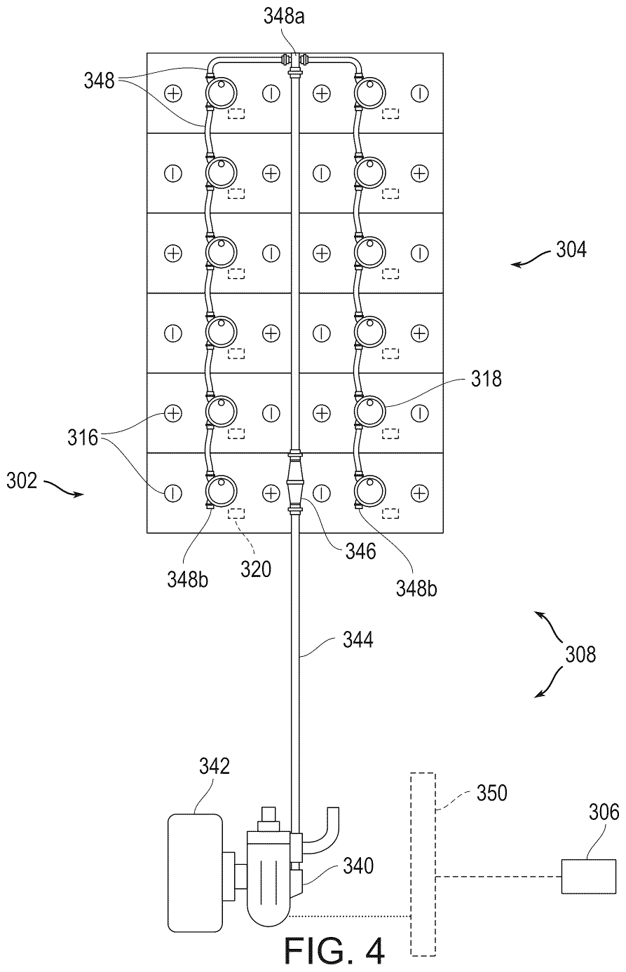

As used herein, “battery” or its plural form “batteries” generally refers to a housing with exposed positive and negative connection terminals. These batteries are arranged in series and/or parallel electrical connection in an arrangement referred to herein as a “battery bank.” FIGS. 1 and 4 described in more detail below depicts general schematic overviews of a battery bank with 6 and 12 batteries, respectively. However it is appreciated that a self-maintained lead acid battery system herein may include a battery bank comprising more than about 20 batteries, for example about 20-480, 24-480, 40-480, 48-480, 20-240, 24-240, 40-240, or 48-240 batteries. In addition, multiple battery banks can be used in an installation. In certain embodiments, multiple battery banks are used in an installation and a separate set of components and sub-systems that form the self-maintained battery system are provided for each battery bank. In certain embodiments, multiple battery banks are used in an installation and certain components and sub-systems that form the self-maintained battery system herein are shared between plural battery banks.

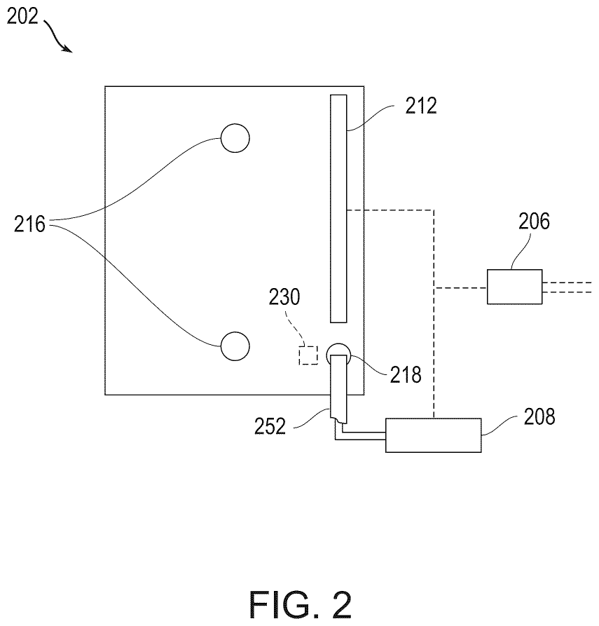

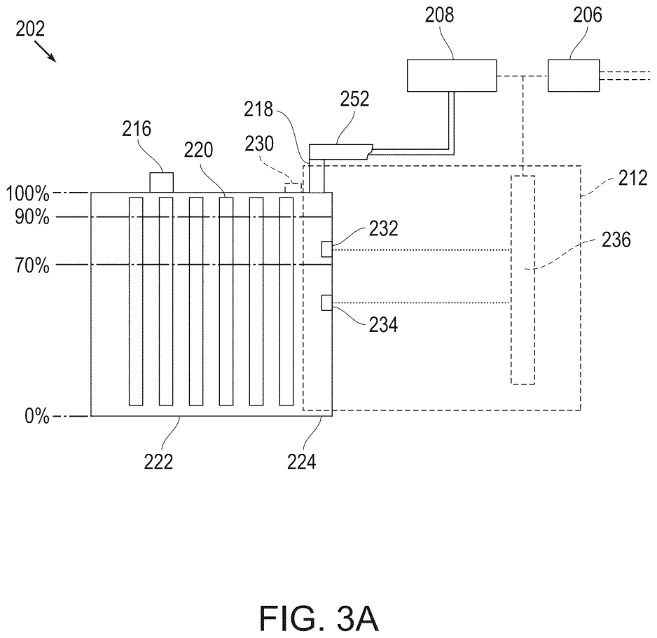

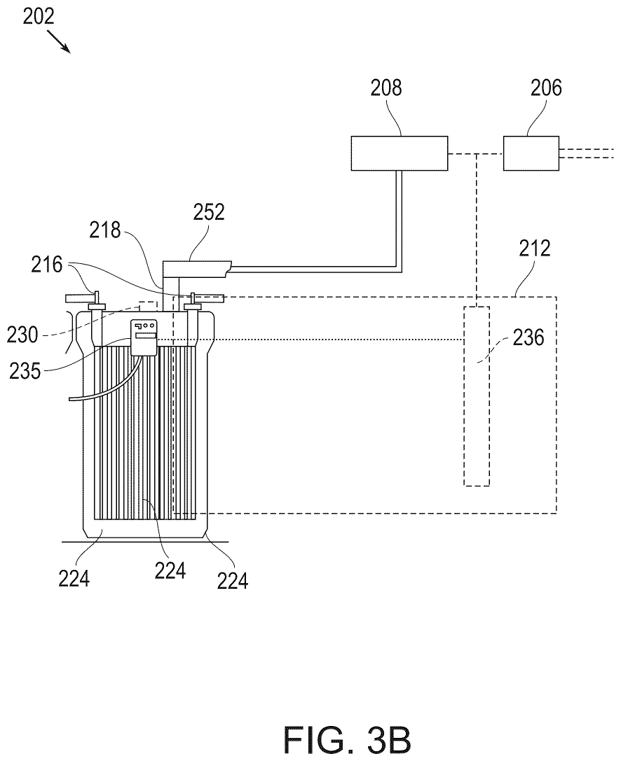

A battery bank and its associated components as disclosed herein form the self-maintained battery system herein. FIGS. 2 and 3 described below depict simplified diagrams of a battery, but it will be appreciated that all known components and structures with a battery are not shown therein. A typical type of battery used in battery banks in the battery system of the present disclosure is a lead acid battery generally including, among other components, one or more sets of cells, for example, six sets of cells each nominally rated for 2.0 volts to form a 12 volt battery. These cells or sets of cells are enclosed in the housing, also referred to as a “casing” or a “jar.” Each lead acid electrochemical cell typically includes a pair of electrodes, such as a lead grid plate as an anode and a second lead grid plate coated with lead oxide as a cathode. The electrodes have suitable conductors connected in series to the exposed positive and negative connection terminals.

The plates are immersed in an aqueous sulfuric acid solution as the electrolyte for the electrochemical cell and as such the jar is constructed of suitable material to contain and resist corrosion from the electrolyte. During charging, reactions include water dissociation at the electrodes forming gaseous products including hydrogen; in embodiments herein the lead acid batteries have venting ports to allow these gases to escape.

The sulfuric acid electrolyte is characterized by a specific gravity (relative to water), for example about 1.2-1.3, 1.23-1.3, 1.26-1.3, 1.2-1.29, 1.23-1.29, 1.26-1.29, 1.2-1.26 or 1.23-1.26, variations depends on the charge state and temperature. These ranges are equivalent to high concentration acids, for example, about 4-7, 4.5-7, 4-6 or 4.5-6 M. If there is electrolyte leakage or spillage in the battery installation, there is risk of exposure by technical field team or other personnel, and/or corrosion of the equipment.

Commercially available batteries that may be included in battery bank(s) in the battery system of the present disclosure include but are not limited to those available from EnerSys (e.g., under the tradename PowerSafe) (Reading, PA, USA), HOPPECKE Batterien GmbH & Co. KG (Brilon-Hoppecke, Germany), and FIAMM Energy Technology (Montecchio Maggiore, Italy).

While these batteries are integral to ensuring continual operation, they inherently pose a risk of environmental exposure to sulfuric acid, and have potential for drying out at abnormally low electrolyte levels thus decreasing battery efficiency and lifetime. This disclosure herein provides a technical solution to these problems, and minimizes or eliminates manual interaction with battery installations, for example on a monthly basis and more frequently during periods of higher temperature seasons. The self-maintained battery system with this technical solution includes a bank of batteries and integrated sub-systems for electrolyte management and monitoring, including a battery electrolyte maintenance sub-system, an external fluid monitoring sub-system and an internal battery electrolyte monitoring sub-system. These sub-systems cooperate during normal operation, during modes and situations requiring a proactive response, and during modes and situations requiring a reactive response.

The herein systems and methods overcome deficiencies of known systems that lack: a mechanism to discover battery cracks and leakages; the capability to detect and control overfilled cells; and a control mechanism for each battery cell with full monitoring mechanism including over-flow sensors and level switch. In certain embodiments a full monitoring mechanism includes the tops, insides and edges of each cell. In certain embodiments a full monitoring mechanism includes the tops, insides and edges of each cell, along with bottom leak sensors. In addition, the herein systems and methods overcome deficiencies related to ignition of hydrogen gas or arc-through in case of an ignition source inside the battery system by avoiding dry cells, by continuous monitoring and reactive filling of distilled water of all batteries in the battery bank(s). In addition, the herein systems and methods include notifications capability; an integrated control system; instant calls; identification of specific battery(ies) having low electrolyte level (normal, “NLEL” or abnormal, “ALEL,” as described herein); and control of minimization of acid fumes. In certain implementations the herein systems and methods are integrated with the telephone/email system to trigger instant call(s) to preconfigured telephone(s) or/and mobile devices with a message indicating the danger at the specific location. with automatic management escalation process via calls/text messages/emails if the electrolyte reaches minimum level; resuming the normal operation (if electrolyte level reaches the optimum level). In certain implementations the herein systems and methods combine the readings from the battery cells sensors and level switch control system to identify the exact precise locations of leaks or other abnormalities and send immediate alerts with precise location information to facilitate inspection for battery cracks/punctures/electrolyte leaks.

The self-maintained battery systems, and methods of operating the self-maintained battery systems, include a battery electrolyte maintenance sub-system (BEMSS), an external fluid monitoring sub-system (EFMSS), an internal battery electrolyte monitoring sub-system (IBEMSS), and a control sub-system (CSS), whereby the BEMSS, EFMSS and IBEMSS are controlled and operated in a cooperative manner via the CSS so as to ensure proper levels of electrolyte within each individual battery of the battery bank and provide protection against internal and external electrolyte abnormalities. These self-maintained battery system and methods of operating the self-maintained battery system mitigate operational impacts and/or safety risks in, for example, IT battery installations hosting the banks of lead acid batteries, by preventing dried batteries, insufficient electrolyte, and flooded batteries. This self-maintained battery system and methods of operating the self-maintained battery system also mitigate risks associated with exposed liquid acid in the battery room.

The self-maintained battery systems, and methods of operating the self-maintained battery systems, advantageously maintain electrolyte with strategic operation of the battery electrolyte maintenance sub-system (BEMSS), avoiding or minimizing the need for manual preventive maintenance or intervention, and to ensure that batteries continue normal charging and discharging operational cycles. For instance, embodiments of the systems and methods herein implement an electric pump which can fill a plurality of cells, in some implementations all cells in a battery bank, faster than normal hand filling. A physical interface for a battery cell battery monitoring system is also provided. In additional implementation, filling operations occur at predetermined times, for instance using one or more external timers.

The self-maintained battery systems, and methods of operating the self-maintained battery systems, advantageously maintain electrolyte at levels to ensure that the batteries remain healthy, that is, they do not dry resulting in potential irreversibly failure such as a short circuit. The self-maintained battery systems, and methods of operating the self-maintained battery systems, advantageously maintain electrolyte at ideal levels mitigating against potential level reductions or flooding during the charging and discharging process cycles. The self-maintained battery systems, and methods of operating the self-maintained battery systems, advantageously avoid the need for excess human exposure to sulfuric acid from the battery electrolyte. The self-maintained battery systems, and methods of operating the self-maintained battery systems, advantageously and comprehensively addresses each of the aforementioned in large battery banks and/or in installations with plural battery banks, as the impact and risk of low electrolyte and/or leaked electrolyte is heightened as the number of lead acid batteries increases in a battery bank.

The integrated system herein generally includes one or more battery banks, for example of lead acid batteries, each having an associated BEMSS, EFMSS and IBEMSS, each in electronic communication with a CSS. The integrated systems prevent over filling or flooding of the battery from over filling of cells, and maintain effective liquid levels to minimize or eliminate the chance the batteries drying out. The BEMSS is effective to automate the process of filling the batteries under control of the CSS, and is integrated with the IBEMSS and the EFMSS by receiving signals therefrom which enable proactive monitoring and control of the electrolyte level within each battery within the battery bank in response to that proactive monitoring. Structural components of the battery electrolyte maintenance sub-system include storage sub-system (e.g., a tank or reservoir) or other liquid source (e.g., spigot connected to external on-demand water source); a pumping sub-system (e.g., an electric pump and one or more pump controllers); a controlled fluid communication sub-system (e.g., tubing or pipes and individually controllable valves associated with each battery or group of batteries, or a monolithic fluid communication structure with integrated individually controllable valves associated with each battery or group of batteries); and battery filling sub-systems (e.g., one or more battery filling plug valves associated with a vent cap port of each battery, and optionally associated sensors).

The internal battery electrolyte monitoring sub-system (IBEMSS) is effective to ascertain the levels of electrolyte within each individual battery. Sensors are provided within the jars of the individual batteries. For example, the IBEMSS generally includes signals and associated sensor sub-systems for “normal low electrolyte level” (“NLEL”) and “abnormal low electrolyte level ” (“ALEL”). These sensors are coupled to the CSS to provide signals which are used by the BEMSS to commence or abstain filling operations.

The external fluid monitoring sub-system (EFMSS) is effective to sense leakage within the battery installation, that is, outside of the battery jars. Such leakage may occur, for instance, due to cracks or other structural degradation of one or more batteries in the bank, for instance due to high or overcharged battery causing expansion of the jar and resulting cracks, or accidental spillage during filling operations. The EFMSS includes one or more sensors, for example located outside of the batteries on the battery trays and/or floor/ground of the battery installation, typically below the batteries themselves. These can be at strategic locations where liquids may accumulate (e.g., at a lower portion of a sloped tray or floor/ground). The sensors can be provided in a series of strips at such locations, for example in the form of a patterned mesh.

In the event of abnormalities one or more proactive responses are undertaken. These proactive responses are undertaken to maintain efficacy of the overall battery bank and associated sub-systems, and the health of the individual batteries therein, as well as the safety of the technical field team or other personnel entering the battery installation.

In certain implementations of a self-maintained system battery system including a BEMSS, an EFMSS, an IBEMSS and a CSS, signals generated (or lack of signals) initiate or stop certain operations herein. In addition, combinations of generated signals are utilized to improve efficacy and safety, including from the IBEMSS and the EFMSS. The IBEMSS generates a signal or a plurality of signals (generally from associated sensor sub-systems for “normal low electrolyte level” (“NLEL”) and “abnormal low electrolyte level” (“ALEL”)), and in certain implementations generates a signal or plural signals related to presence of an overflow condition (“OFC”) when electrolyte is discharged from one or more of the battery filling system plugs. The EFMSS generates a signal, or plural signals, related to presence of abnormal external leakage (“AEL”) to the batteries, and in certain implementations generates a signal or plural signals related to presence of an OFC. In certain implementations the BEMSS generates a signal or plural signals related to the presence of an OFC.

Responsive filling operations of the BEMSS are abstained when the IBEMSS indicates operational electrolyte levels, which can be a specific signal and sensor sub-system, or a lack of NLEL and ALEL. Filling operations of the BEMSS are abstained when the EFMSS indicates AEL, which can be related to one or more sensors that detect abnormal leakages external to the batteries, for example, upon battery trays and/or on the floor of the battery installation. Filling operations are abstained when the OFC is detected, whereby electrolyte is discharged outside of the battery through the battery filling system plug, for example due to one or more of overfilling, leaking or expelling through the battery filling system plug. This state of abstained filling operations can include non-operation of the pump, or operation of the pump with liquid bypassing all filling ports, and returning to a storage tank. BEMSS responsive filling operations occur when the IBEMSS indicates a NLEL normal low electrolyte level signal, if the EFMSS indicates an absence of AEL, and if the there is an absence of an OFC.

In some embodiments scheduled filling operations of the BEMSS occur at predetermined time(s) for all or certain batteries in the battery bank; in conjunction with the systems herein, these are controlled so that, at the predetermined time(s), if the EFMSS indicates an absence of AEL, and if the there is an absence of an OFC, the scheduled filling occurs. In some embodiments scheduled filling operations of the BEMSS coincide with charging cycles of a battery or group of batteries; if the EFMSS indicates an absence of AEL, and if the there is an absence of an OFC, scheduled filling occurs.

BEMSS filling operations include responsive filling operations initiated by a NLEL signal indicated by the IBEMSS or BEMSS scheduled filling operations (based on predetermined filling times and/or coinciding with the charging cycle). These BEMSS filling operations including those described above occur if the EFMSS indicates an absence of AEL, and if the there is an absence of an OFC. During the BEMSS filling operations, the IBEMSS continues monitoring; when the electrolyte level is at a predetermined level or range corresponding to healthy battery operations, filling stops. Carrying out the BEMSS filling operations includes adding a predetermined amount of distilled water by commencing operation of the pump and directing it to the battery(ies) be filled through the associated filling port(s), or by opening associated valves to direct distilled water accumulated in the line to the battery(ies) to be filled through the associated filling port(s). The “battery(ies) to be filled” refer to those scheduled for filling during BEMSS scheduled filling operations, and for responsive filling operations those battery(ies) indicating a NLEL signal by the IBEMSS. In certain embodiments an operational electrolyte level signal is sent to the CSS, for example, by discontinuing operation of the pump and hence stopping flow of liquid to the battery(ies) previously being filled through the associated filling port(s), or closing valves associated with the battery(ies) previously being filled through the associated filling port(s).

In certain implementations, during filling operations the IBEMSS can operate to seek indication from a sensor corresponding said operational electrolyte level in each battery (or only the battery(ies) currently under filling operations) to improve efficiency; when filling is completed and the operational electrolyte level signal is indicated, regular monitoring by the IBEMSS resumes.

Optionally, an external indicator presents the state of the battery installation and condition of one or more batteries is provided, including AEL, OFC, NLEL and ALEL, and whether or not the EFMSS is filling under responsive filling or scheduled filling; said indication can also include alerts for AEL, OFC, NLEL and/or ALEL. The presented indicator can include one or more of an increased or distinctive audible signal, voice alerts, blinking visual alerts, text message alerts, icon image message alerts, real-time camera image alerts, voice alerts, or the like; said alert(s) may be cleared when the electrolyte level is at a predetermined level or range corresponding to healthy battery operations, or the AEL condition is resolved.

Accordingly, the systems and methods herein implement the IBEMSS, EFMSS, and BEMSS to automate the filling process for battery banks to avoid low electrolyte level in the battery resulting in dried batteries. In certain implementations the integrated systems and methods herein provide continuous water filling with the exact amounts of distilled water during charging operations. A flow limit switch is connected to the battery filling sub-system to alert when there are potential issues and to alert during an event in which the electrolyte level of one or more batteries reaches minimum. The system integrates intelligence to provide alarms warning a technical field team or other personnel with a battery low level signal through a relay to switch the automatic pump to operate to normalize the electrolyte level inside battery cells, and continue monitoring until the electrolyte reaches the necessary level at which point a signal is sent to switch off the pump.

In certain implementations, the integrated systems and methods for electrolyte management of batteries in a battery bank are operable to push an alert, for example to a centralized network operation center, concerning an abnormality detected by the internal battery electrolyte monitoring sub-system or the external fluid monitoring sub-system. In certain implementations, the integrated system for electrolyte management of batteries in a battery bank is operable to push an alert, for example to a centralized network operation center, concerning an abnormality detected by the internal battery electrolyte monitoring sub-system related to an excessively low electrolyte level, at which point the event push an essential notification to the centralized network operation center, for example demanding immediate attention by dispatching a technical field team or other personnel to begin inspection and if necessary remediation procedures.

In certain implementations, the integrated systems and methods prevent or minimize the likelihood of water flooding in the battery. In certain implementations, each battery is equipped with sensors in communication with one or more controllers that direct filling operations accordingly. In certain implementations, each battery is equipped with sensors, and the liquid flow path includes one or more relays in communication with one or more controllers that direct filling operations accordingly, e.g., by operating a pump switch includes and/or by opening/closing valves in the liquid flow path. For example, when a sensor in an individual battery associated with an abnormally high electrolyte level is activated, the automatic water filling operation will trip. To prevent water flooding, level and/or overflow sensors, which are associated with relays that will trip the automatic water filling operation in case the sensors are flooded with water. In addition, in certain implementations the systems and methods are capable of detecting leakage or abnormal electrolyte loss one or more level sensors, including an abnormal low electrolyte level sensor, which is below the normal low electrolyte level sensor. Moreover, when electrolyte inside the battery drops to a level that results in sensing of the abnormal low electrolyte level sensor, a signal will be sent to stop the refilling process, for example to the main tank and/or pump.

In certain implementations the integrated systems and methods herein provide continuous monitoring of the condition of the individual batteries including the electrolyte level in each battery. Additionally, in certain implementations the integrated systems and methods herein provide the technical field team or other personnel alerts and data about the exact environmental condition of the facility before attempting to enter, thus promoting high safety standards for personnel. Moreover, in certain implementations the integrated systems and methods herein automatically initiates calls or messages to the technical field team or other personnel for immediate attention and action under certain conditions; if the abnormalities or other detrimental conditions worsen, for example the electrolyte level of a given battery reaches minimum level and its associated abnormal low electrolyte level is activated plural times, an escalated call or message to the technical field team or other personnel and also management is initiated. Further, the integrated systems and methods herein are capable of determining the exact battery with low electrolyte level through the integrated control and connectivity which combines the readings from the internal battery electrolyte monitoring sub-system. Moreover, the integrated systems and methods herein contain suitable intelligence to halt battery refilling when the electrolyte level reaches a normal level. The integrated systems and methods herein are also capable of identifying whether there are battery cracks/leaks, in which case filling is halted until the condition alleviated.

In certain embodiments the integrated systems and methods herein also are in communication with a battery charging control system and/or battery charging breaker. In such embodiments in the event of an abnormality detected by the self-maintained battery system, a signal is sent to the battery charging control system to abstaining from charging, or a signal is sent to a battery charging breaker or shunt to isolate the charging circuit. Further, in such embodiments in the event of an abnormality detected in the charging system, filling operations are halted until the condition(s) corrected. In an implementation a charging system abnormality comprises a voltage below a predetermined threshold (e.g., below about 1.75 volts in a lead acid battery described herein). In an implementation a charging system abnormality comprises an electrolyte specific gravity below a predetermined threshold (e.g., below about 1.2 in a lead acid battery described herein).

Operation of the herein systems and methods will improve efficacy and efficiency of smart preventive maintenance to elevate reliability and safety measures in battery installations. The herein systems and methods are effective for unmanned and hard-to-reach buildings such as the offshore and repeater sites. Accordingly deleterious consequences from low electrolyte levels and even dried batteries are avoided, ensuring safe business continuity; concomitantly filling of a battery is avoided when electrolyte levels drop to an abnormal low electrolyte level to mitigate against effects of battery defects causing those abnormalities. preventing abnormal events that may result in battery internal short circuit, thus ensuring safe business continuity. This comprehensive solution encompasses battery electrolyte maintenance sub-system, an external fluid monitoring sub-system and an internal battery electrolyte monitoring sub-system which cooperate during normal operation, modes requiring proactive response, and modes requiring reactive response

Having described various embodiments of the integrated systems and methods for electrolyte management of batteries in a battery bank including multi-function refilling, electrolyte level sensing, and advance sensing of leakages with proactive response, non-limiting examples are described with respect to the accompanying drawings.

FIG. 1A is a schematic block diagram of an exemplary embodiment of a self-maintained battery system 100 including sub-systems for monitoring and managing electrolyte levels according to the present disclosure. The self-maintained battery system 100 may be implemented, for example, within a battery installation, such as in one or more IT battery rooms on-site of an organization, at a remote location, or a combination thereof. The battery installation contains one or more rechargeable lead-acid batteries 102, such as flooded (wet) rechargeable lead-acid batteries, or stacks thereof, for example in the configuration of a battery bank 104. While such lead-acid batteries have the advantage of rechargeability, electrolyte management and maintenance are necessary; according to the self-maintained battery system 100 herein, electrolyte management and maintenance is provided by cooperative control under direction of a control sub-system (CSS) 106 to: control operations of a battery electrolyte maintenance sub-system (BEMSS) 108 and to provide safety control by abstaining from charging during certain conditions; receive data from an external fluid monitoring sub-system (EFMSS) 110, an internal battery electrolyte monitoring sub-system (IBEMSS) 112, optionally the BEMSS 108, an optional voltage monitoring sub-system; and optionally one or more other sources; and push alerts and notifications via a notification sub-system (NSS) 114. In certain implementations, optional additional battery banks 104′ and 104″ are provided (indicated as optional by dotted lines in the representations in FIG. 1A). In embodiments implementations (not shown) each of the additional battery banks 104′ and 104″ has a set of components and sub-systems that are independent of one another. In embodiments implementations (not shown) each of the additional battery banks 104′ and 104″ has a set of components and sub-systems that are independent of one another except for a common NSS 114. In embodiments implementations, as indicated the additional battery banks 104′ and 104″ have components and sub-systems that are independent of one another except for the CSS 106 (as indicated by dotted lines connecting CSS 106 and the additional battery banks 104′ and 104″), whereby the functionality and communications of the CSS 106 and the NSS 114 pertain to the battery bank 104 and the additional battery banks 104′ and 104″.

In general, the CSS 106 contains a processor and memory, and is programmed to operate and/or receive data from the BEMSS 108, the EFMSS 110 and the IBEMSS 112 (or plural of these subsystems in embodiments in which multiple battery banks are under control of the CSS 106, each battery bank having its own BEMSS 108, EFMSS 110 and IBEMSS 112). The CSS 106 can include one or more computing devices, each containing a processor, memory and associated components as described herein programmed to execute software instructions to carry out the self-maintenance features including but not limited to sensing, filling, abstaining from filling, abstaining from charging, and pushing notifications and alerts. In certain embodiments the CSS 106 comprises a programmable logic controller, often referred to as a “plc” controller. An example of such a controller is an Arduino controller.

In certain implementations, the electrical connectivity between batteries 102 is controllable. For example, solenoid switches in electronic communication with the CSS 106 for feedforward action, for example, as a shunt to manipulate connections between batteries, based feedback from one or more of the BEMSS 108, EFMSS 110 or IBEMSS 112, or another integrated system such as a voltage monitoring system. FIG. 1B is an overview of the connection of batteries deployed in the self-maintained battery system herein and including. For example, batteries 102 are shown in a bank connected in parallel by connecting the positive terminals 116 to a positive junction block busbar 116a and to the load, and the negative terminals 116 to a negative junction block busbar 116a and to a ground. The CSS 106 is connected to a shunt 116b to provide reactive control as described herein in operations of the self-maintained battery system.

FIGS. 2, 3A and 3B show embodiments of an individual battery 202, in which FIG. 2 is a general top view, FIG. 3A is a sectional view according to an embodiment, and FIG. 3B is a sectional view according to another embodiment, to illustrate for example the operation and integration of an internal battery electrolyte monitoring sub-system (IBEMSS) 212 and a battery electrolyte maintenance sub-system (BEMSS) 208 (shown as representative boxes, and which is are embodiments of the BEMSS 108 and IBEMSS 112 in FIG. 1A). The IBEMSS 212 and BEMSS 208 are in communication with and with a control sub-system 206 (for example an embodiment of CSS 106 in FIG. 1A and FIG. 1B) shown connected to the BEMSS 208 and IBEMSS 212), with additional connections (not shown), for example to the EFMSS 110 and NSS 114, and/or an optional voltage monitoring sub-system as described hereinbelow.

As shown in FIGS. 3A and 3B, the battery 202 typically includes electrodes 220 and electrolyte 222 within a jar or housing 224. Also shown in FIGS. 2, 3A and 3B are battery system filling plugs 218 provided for each battery, which are in fluid communication with the BEMSS 208 via a conduit 252. The electrodes (e.g., each as a pair of electrodes, such as a lead grid plate as an anode and a second lead grid plate coated with lead oxide as a cathode) have suitable conductors connected in series to the exposed terminals 216 (e.g., positive and negative connection terminals). The electrolyte 220 is typically an aqueous sulfuric acid solution, and the jar 224 is constructed of suitable material to contain and resist corrosion from the electrolyte, such as polypropylene or polyvinyl chloride. The sulfuric acid electrolyte 220 is characterized by a specific gravity (relative to water), for example about 1.2-1.3, 1.23-1.3, 1.26-1.3, 1.2-1.29, 1.23-1.29, 1.26-1.29, 1.2-1.26 or 1.23-1.26; variations depend on the charge state and temperature.

In certain embodiments, an optional overflow sensor 230 situated on the top of the battery (as indicated in dashed lines in FIGS. 2, 3A, 3B and 4). The overflow sensor 230 can be installed to the top of the battery jar with suitable hardware or brackets, adhered to the top of the battery jar with suitable adhesive, and/or integrated within the top surface itself, for instance with an indented region to adapt the overflow sensor(s). Signals from the overflow sensors to the controller(s) may be by wired or wireless communications. The overflow sensors may form part of any one or more networks of sensors and components described herein, including those which are part of the IBEMSS, those which are part of the EFMSS, and those which are part of the BEMSS. An implementation herein includes an overflow sensor 230, for example proximate to the battery filling system plug 218; if an overflow occurs it will be sensed and signal the controller to stop the water pump. Examples of suitable overflow sensors 230 include but are not limited to those commercially available from OMRON Industrial Automation (Hoffman Estates, IL USA) as sensor F03-16PE, or from Honeywell International Inc. (Charlotte, North Carolina, USA) under the tradename BES Series battery sensors. The overflow sensors 230 may be provided in addition to any other overflow sensing functionality, for example, optionally integrated with a battery system plug valve as described below, and/or optionally integrated with IBEMSS external level sensor 235 described herein.

The IBEMSS 212 generally includes a plurality of sensors for ascertaining whether there exists a normal low level electrolyte condition or an abnormal low level electrolyte condition. Signals from the level sensors to the controller(s) may be by wired or wireless communications. The level sensors are integrated within the housing of the battery (for instance along a side wall generally parallel to the plane of the battery electrodes). The level sensors can be installed on a side wall with suitable hardware or brackets, adhered to the side wall with an adhesive resistant to the sulfuric acid electrolyte, and/or integrated within the side wall itself, for instance with an indented region to adapt the level sensor(s).

Examples of suitable electrolyte level sensors 232, 234 include but are not limited to those commercially available from HOPPECKE Batterien GmbH & Co. KG (Brilon-Hoppecke, Germany) under the trade names trak|aquacheck, from VERTIV (Columbus, Ohio, USA) under the tradename (Albér™ ELS₂), or from Honeywell International Inc. (Charlotte, North Carolina, USA) under the tradename BES Series battery sensors.

In certain embodiments, as shown in FIG. 3A, level sensors include an IBEMSS normal low level sensor 232 and an IBEMSS abnormal low level sensor 234 within the housing. In normal operation, the level sensors 232 and 234 are immersed in electrolyte. As electrolyte loss occurs, one or both of the level sensors 232 and 234 are activated, depending on the level of electrolyte loss. In certain embodiments, the IBEMSS normal low level sensor 232 is at a position in the housing corresponding to about 70-90, 75-90 or 80-90 volume percent, and the IBEMSS abnormal low level sensor 234 is at a position in the housing corresponding to about 0-70, 10-70, 20-70, 30-70, 40-70 or 50-70 volume percent, wherein these level are relative to the amount of electrolyte normally within the container, that is, corresponding to a 100% electrolyte level prior to flooding. The sensors 232 and 234 are operable to send a signal to the CSS 206 (optionally via an IBEMSS controller 236) when they are no longer immersed in electrolyte.

In certain embodiments, as shown in FIG. 3B, a level sensor includes an IBEMSS external level sensor 235, for example, that employs infrared signals, to determine operational levels, normal low level, and abnormal low level. The sensor 235 is operable to send a signal to the CSS 206 (optionally via an IBEMSS controller 236) when normal low level is detected or when an abnormal low level is detected. In additional embodiments, the IBEMSS external level sensor 235 also includes functionality for overflow sensing, which may be redundant to other overflow sensing capabilities in the system herein. Examples of suitable IBEMSS external level sensors 235 include but are not limited to those commercially available from VERTIV (Columbus, Ohio, USA) under the tradename (Albér™ ELS₂), or from Honeywell International Inc. (Charlotte, North Carolina, USA) under the tradename BES Series battery sensors.

In certain embodiments IBEMSS 212 also includes an IBEMSS controller 236, which may be in electronic communication with all sensors in all batteries of the battery bank, or in certain embodiments plural IBEMSS controllers 236 are provided. In certain embodiments multiple banks are provided and an IBEMSS controller 236 is provided for each bank. The IBEMSS controller 236 may, for example, be programmed to translate the signals from one or both of level sensors 232 and 234, and pass corresponding data to the CSS 206 for action if called for and optionally logging.

At the time of installation, individual sensor identifications, e.g., for the overflow sensors 230, and the level sensors 232 and 234, or 235, are stored in a database along with installation location (e.g., including an identification of the battery within which the sensor(s) is/are installed); upon activation of a sensor the control system(s) herein thus have the capability to precisely determine the affected battery.

FIG. 4 is a schematic view of a portion of the battery system including a battery bank 304 having a plurality of batteries 302, depicting components and connectivity of a battery electrolyte maintenance sub-system (BEMSS) 308 (as an example of BEMSS 108 or 208 hereinabove) under control of a CSS 306. Strategic operation of the BEMSS 308 under control of the CSS 306 avoids or minimizes the need for manual preventive maintenance or intervention, and ensures that batteries continue normal charging and discharging operational cycles. For instance, embodiments of the systems and methods herein implement an electric pump 340 which under control of the CSS 306 can rapidly fill a plurality of individual batteries 302, in some implementations all batteries 302 in a battery bank, based on scheduled filling or responsive to a set of conditions herein. Filling can occur in parallel so that a plurality of individual batteries 302 or all batteries 302 are effectively filled simultaneously during filling operations, with exceptions for any batteries 302 for which filling is avoided due to an abnormality. The electric pump 340 generally receives water, such as distilled water, or aqueous sulfuric acid, from a reservoir 342. In alternative embodiments, another liquid source may be used instead of or in conjunction with the reservoir 342 (e.g., a spigot connected to external on-demand water source, not shown). The pump 340 provides fluid communication with the liquid source and the batteries 302 via a main distribution conduit 344, optionally a filter 346, and connecting conduits 348, formed of suitable material and of suitable diameter to permit sufficient water flow. A T-piece 348a is provided, for example, to distribute liquid to batteries 302 on each of the two sides of the battery bank 304 through portions of the connecting conduit 348, with end caps 348b closing the liquid circuit. At each battery 302 a battery filling system plug 318 is provided to receive liquid from the associated portion of the connecting conduit 348.

In certain embodiments the CSS 306 provide signals to the pump 340 to turn it on or control the fluid flow rate, and control the valves in the battery filling system plugs 318. In certain embodiments the BEMSS 308 also includes a BEMSS controller 350 that communicates with the CSS 306; in such embodiments the BEMSS controller 350 is in electronic communication with pump 340 and the battery filling system plugs 318, and is programmed to provide signals to the pump 340 to turn it on or control the fluid flow rate, and control the valves in the battery filling system plugs 318.

The conduits and valves therein provide a controlled fluid communication sub-system. In certain implementations the conduits may be tubing or pipes and individually controllable valves associated with each battery or group of batteries. In certain implementations a monolithic fluid communication structure is provided (not shown) with integrated individually controllable valves associated with each battery or group of batteries.

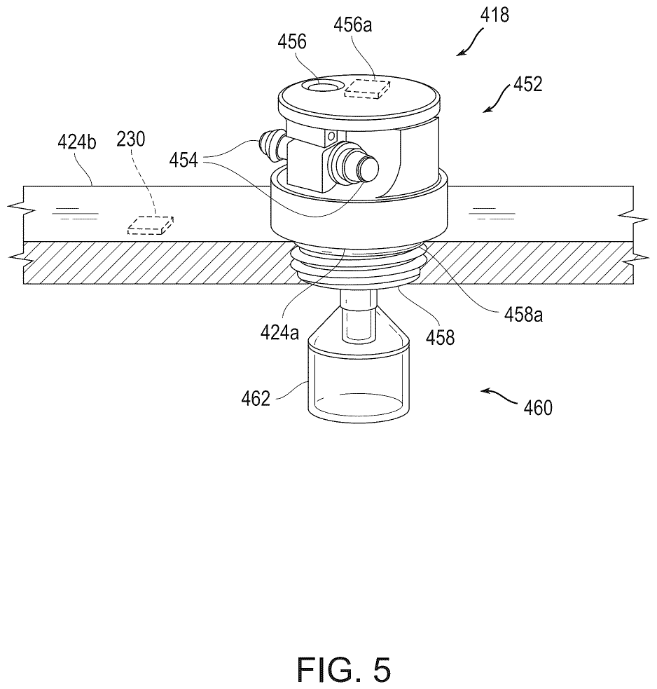

FIG. 5 is a view of an embodiment of a plug 418 used in the self-maintained battery system herein, referred to as a battery filling system plug (BFSP). While plug 418 is shown and described with respect to FIG. 5, a suitable plug can also be a configuration other than threaded, e.g., push-in, bayonet, twist-lock, or clip-in.

In the embodiment of FIG. 5, the BFSP 418 is screwed into a threaded hole 424a on a top portion 424b of the housing, and includes fluid connection ports 454 to enable fluid communication with the source of liquid for electrolyte maintenance, e.g., a conduit as shown in FIG. 3. The BFSP 418 includes a top body portion 452 that is external to the battery; the aforementioned fluid connection ports 454; a gas vent port 456 for venting gasses formed, for example, during charging operations; a threaded insert 458 and associated seal 458a, such as an O-ring; an internal body portion 460 that protrudes within the battery housing including a float 462. In certain embodiments, an optional overflow sensor 456a is provided on the BFSP 418 to sense liquid overflow, for example due to overfilling and/or leakage. The overflow sensor 456a may be provided as the sole overflow sensor associated with each battery in the system; alternatively, one or more additional overflow sensors with each battery may be provided, such as overflow sensors 230 described herein, to provide redundancy.

During filling, liquid is introduced through a fluid connection ports 454 and passes through the top body portion 452 and internal body portion 460 into the battery housing. The float 462 is normally in an open position during filling, and serves as a shut-off valve to prevent battery flooding during operation; when the liquid levels rise and displace the float, a float body pushes up and plugs the liquid path between the top body portion 452 and internal body portion 460 to prevent further water flow, for example until the pressure is released and the float drops back to the open position. In addition, in certain embodiments the float is associated with an internal overflow mechanism. The system and method herein increases safety and reliability with redundant capabilities of halting pump operations during abnormalities, and/or by selectively stopping liquid flow to the affected battery(ies) by a controllable valve.

Examples of BFSP 418 include but are not limited to those commercially available from BFS GmbH (Bergkirchen, Germany) such as Threaded Plug III M27 C51000, or those commercially available from Battery Watering Technologies (Clemmons, North Carolina USA) or Bater Sp. o.o. (Warsaw, Poland).

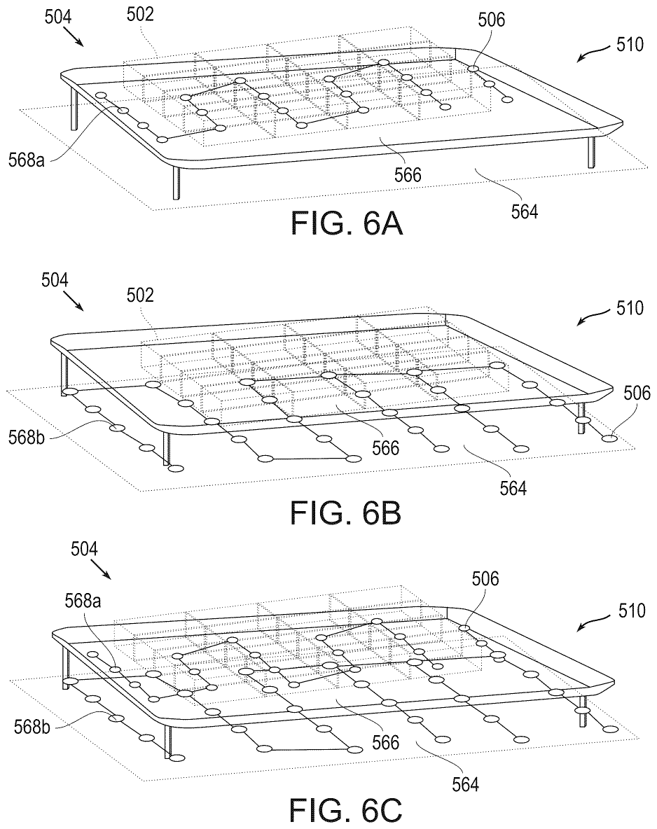

FIGS. 6A, 6B and 6C are schematic diagrams of exemplary external fluid monitoring sub-systems deployed in the self-maintained battery system (such as EFMSS 110 hereinabove). In the embodiments of FIGS. 6A, 6B and 6C, batteries 502 are connected to form a battery bank 504 and are positioned on a battery tray 566, which in turn is positioned on a battery room floor 564. In the embodiment of FIG. 6A, a plurality of leak sensors 568a are interconnected to the system and installed on the battery tray 566. For example, in one implementation, a grid or series of rows of leak sensors 568a are interconnected and installed on the battery tray 566. In the embodiment of FIG. 6B, a plurality of leak sensors 568b are interconnected to the system and installed on the battery room floor 564. For example, in one implementation, a grid or series of rows of leak sensors 568b are interconnected and installed on the battery room floor 564. In the embodiment of FIG. 6C, a plurality of leak sensors 568a are interconnected to the system and installed on the battery tray 566, and a plurality of leak sensors 568b are interconnected to the system and installed on the battery room floor 564. For example, a grid or series of rows of leak sensors 568a are interconnected and installed on the battery tray 566, and a grid or series of rows of leak sensors 568b are interconnected and installed on the battery room floor 564. In any or all of these embodiments, one or more leak sensors may be installed on one or more batteries (not shown for clarity of exposition in the FIGS. 6A, 6B and 6C). The leak sensors 568a, 568b or both 568a and 568b are interconnected to the control sub-system 506 in FIGS. 6A, 6B and 6C, and signals from the leak sensors to the controller(s) may be by wired or wireless communications.

In operation, upon activation of any one or more of the leak sensors 568a, 568b, those which may be installed on the batteries, or a combination thereof, a signal is sent to the control sub-system 506 (with alert signal with location of the sensor) The leak sensors are water or liquid sensors that are activated by contact with water or liquid, for example from leakage of one or more batteries such as from cracks in the battery jar. Examples of leak sensors 568a, 568b include but are not limited to commercially available from OMRON Industrial Automation (Hoffman Estates, IL USA) as sensor F03-16PE or from Honeywell International Inc. (Charlotte, North Carolina, USA) under the tradename BES Series battery sensors.

In certain implementations, individual sensor identifications are stored in a database along with installation location; upon activation of a sensor, or plurality of systems, the control system(s) include a response based on the location of the abnormality.

In certain implementations, battery identifications are stored in a database, with information location, and individual sensor identifications are stored in a database along with installation location. The individually identifiable leak sensors are positioned in locations (on the floor and/or the tray) associated with one or more identifiable batteries. Upon activation of a particular one or more of the leak sensors, any ongoing or planned filling operations of that battery or group of batteries is halted or cancelled until the situation is resolved; in such embodiments, filling operations for other batteries or groups of batteries may continue.

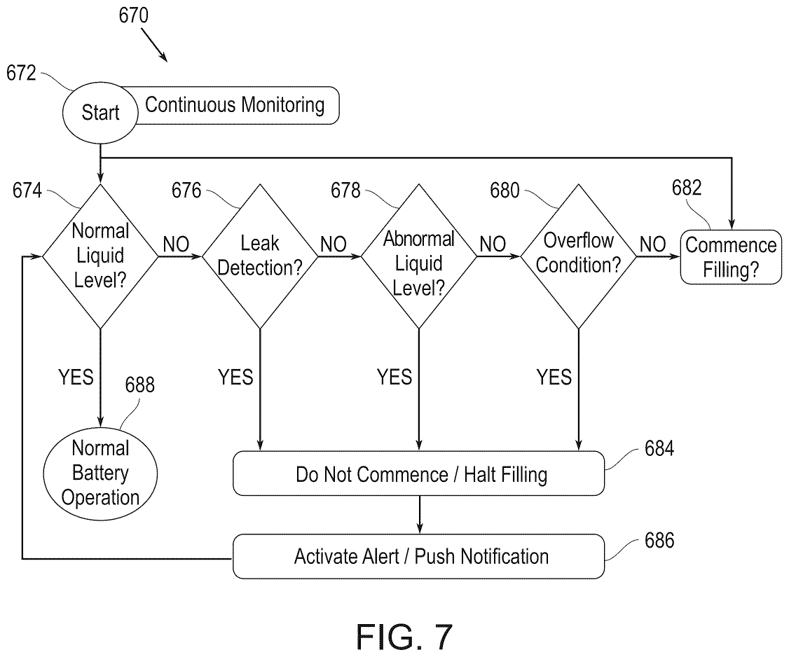

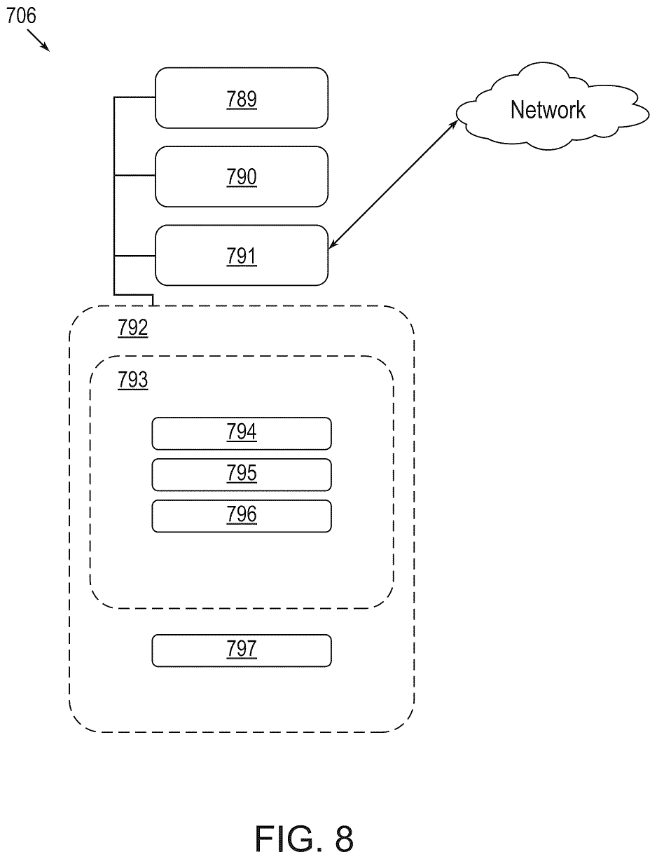

A logical flow diagram of a method of operation 670 of a self-maintained battery system as described herein is shown in FIG. 7. The methods described herein may be implemented by a series of computer-executable instructions residing on a storage medium such as a carrier wave, disk drive, or other computer-readable medium, as software and/or firmware running on a programmable microprocessor and/or programmable logic controller, or implemented in hardware utilizing either a combination of microprocessors or other specially designed application specific integrated circuits, programmable logic devices, or various combinations thereof.

A routine is provided to be carried out by the control sub-system based on feedback from the plural sensors about conditions in the batteries of the battery bank, and feedforward action based on combinations of conditions. The routine is carried out upon each battery or battery set (i.e., the level sensors and overflow sensor, and any localized leak sensors) and includes proactive responses 672, 674, 676, 678, 680 and 682, reactive responses 684 and 686, and normal operation 688 including normal discharging and recharging cycles. In addition, embodiments herein include continuous monitoring and reactive responses, which occur separately and redundantly relative to the sensing steps 676 and 680, and the proactive responses 684 and 686. The battery bank may be divided into individual batteries for carrying out the routine, for example, corresponding to N batteries in the battery bank. Alternatively, the battery bank may be divided into sets for carrying out the routine on multiple batteries within the set in parallel, for example, corresponding to M battery sets in the battery bank.

In certain embodiments, the battery bank is divided into N individual batteries for carrying out the routine corresponding to the total number of batteries N in the battery bank. The routine shown is carried out upon the batteries 1 through N. In certain embodiments the routine is carried out at a predetermined time for each battery. In certain embodiments the routine is carried out a predetermined time for each battery that corresponds to a time before a scheduled filling time for that battery. In certain embodiments a time before a scheduled filling time is within a margin of 5-20% of an average time to run the routine, for instance, in the range of about 1-100 microseconds. In certain implementations the routine is carried out upon battery 1 at a predetermined time to completion (i.e., normal operation 688), then the routine is carried out upon battery 2 sequentially to completion, and so on until battery N is reached. In other implementations, the routine is carried out upon battery 1 at a predetermined time; whether or not completion of the routine upon battery 1 occurs, the routine is then carried out upon battery 2 at a predetermined time; and so on until the routine is carried out upon battery N at a predetermined time; in these implementations, the routine may be carried out upon multiple batteries in parallel.

In certain embodiments, the battery bank is divided into designated group of batteries or battery sets, for carrying out the routine on multiple batteries within the set in parallel. For example, M battery sets may be provided encompassing all batteries in the battery bank. In certain embodiments the routine is carried out at a predetermined time for each designated group of batteries. In certain embodiments the routine is carried out a predetermined time for each designated group of batteries that corresponds to a time before a scheduled filling time for that designated group of batteries. In certain embodiments a time before a scheduled filling time is within a margin of 5-20% of an average time to run the routine, for instance, in the range of about 1-100 microseconds. In certain implementations the routine is carried out upon battery set 1 at a predetermined time to completion (i.e., normal operation 688), then the routine is carried out upon battery set 2 sequentially to completion, and so on until battery set M is reached. In other implementations, the routine is carried out upon battery set 1 at a predetermined time; whether or not completion of the routine upon battery set 1 at a predetermined time occurs, the routine is then carried out upon battery set 2 at a predetermined time; and so on until the routine is carried out upon battery set N at a predetermined time; in these implementations, the routine may be carried out upon multiple batteries sets in parallel.

In certain embodiments during the method 670 continuous monitoring of the leak sensors in all batteries of the battery bank, and the overflow sensors in the system, occurs; reactive responses are provide upon sensing an abnormal condition; this continuous monitoring and separately and redundantly relative to the sensing steps 676 and 680, and the proactive responses 684 and 686. In such embodiments, “start” 672 refers to commencement of automated filling by the BEMSS; at this time and prior to this time, both continuous monitoring of the leak sensors and continuous monitoring of the overflow sensors are occurring with feedback provided to the CSS; any active leak or overflow condition determined by the CSS during continuous monitoring (a) sends instructions for responsive action to the BEMSS, wherein the responsive action is to halt any ongoing filling operations or to cancel planned filling operations and (b) sends instructions for responsive action to the NSS, wherein the responsive action is to activate one or more alerts, to push one or more notifications, or a combination thereof; these responsive actions are cleared when the CSS receives feedback indicating resolution of the leak or overflow condition.

In certain embodiments during the method 670 continuous monitoring of the leak sensors, the overflow sensors and the level sensors in all batteries of the battery bank occur with normal reactive responses upon sensing an abnormal condition. In certain implementation of such embodiments, “start” 672 refers to commencement of automated filling by the BEMSS; at this time and prior to this time, continuous monitoring of the level sensors, continuous monitoring of the leak sensors, and continuous monitoring of the overflow sensors are occurring; any active leak, abnormal low liquid level or overflow condition determined by continuous monitoring halts any ongoing filling operations, or cancels planned filling operations, and activates an alarm and/or sends notifications to personnel until resolution of the leak, abnormal low level, or overflow condition; in such implementations the continuous monitoring and reactive responses occurs separately and redundantly relative to the sensing steps 674, 676, 678 and 680, and the proactive responses 684 and 686. In other implementation of such embodiments, “start” 672 refers the start of filling of a battery or set of batteries as a result of a normal low electrolytes signal, for example the presence of a signal from a normal low level sensor 232 as a result of continuous monitoring.

In certain embodiments, during the method 670 continuous monitoring of the abnormal low leak sensors, the overflow sensors and the level sensors in all batteries of the battery bank occur with normal reactive responses upon sensing an abnormal condition. In certain implementation of such embodiments, “start” 672 refers to commencement of automated filling by the BEMSS; at this time and prior to this time, continuous monitoring of the abnormal low level sensors, continuous monitoring of the leak sensors, and continuous monitoring of the overflow sensors occur; any active leak, abnormal low liquid level or overflow condition determined by continuous monitoring halts any ongoing filling operations, or cancels planned filling operations, and activates an alarm and/or sends notifications to personnel until resolution of the leak, abnormal low level, or overflow condition; in such implementations the continuous monitoring and reactive responses occurs separately and redundantly relative to the sensing steps 676, 678 and 680, and the proactive responses 684 and 686.

During filling operations (scheduled or as a result of a normal low electrolytes signal), proactive monitoring of a given battery or group of batteries occurs (battery or a battery set), above and beyond any continuous monitoring of the embodiments above. At step 674, a proactive determination is made as to whether or not the liquid level is normal, by detecting the absence or presence of a normal low level signal from the normal low level sensor(s) of the IBEMSS. In the absence of a normal low level signal, the routine proceeds to step 688 for normal battery operation and filling is avoided. If the normal low level sensors are active, for example the presence of a signal from a normal low level sensor 232, the routine proceeds to proactively determine whether or not there is a leak at step 676, by detecting the presence of absence of a leak signal from a leak sensor in the EFMSS. If a leak is detected, the first and second reactive responses 684, 686 occur, which are to not commence filling, or halt filling if it is in progress (response 684), and to initiate an alert and/or push a notification to a centralized network operations center (response 688).

If no leak is detected at step 676, the routine proceeds to the next proactive step 678, to determine whether or not the low electrolyte level is an abnormal low electrolyte level by detecting the presence or absence of an abnormal low level signal from an abnormal level sensor in the IBEMSS. If the abnormal low level sensors are active, for example the presence of a signal from an abnormal low level sensor 234, the first and second reactive steps 684, 686 occur, which are to not commence filling, or halt filling if it is in progress (step 684), and to initiate an alert and/or push a notification to a centralized network operations center (step 688).

If there is no abnormal low level signal detected at step 678, the routine proceeds to the next proactive step 678, to determine whether or not there is an overflow condition by detecting the presence or absence of a signal from the overflow sensor. If there is an overflow condition, the first and second reactive steps 684, 686 occur, which are to not commence filling, or halt filling if it is in progress (step 684), and to initiate an alert and/or push a notification to a centralized network operations center (step 688).

If there is no overflow condition, the routine proceeds to step 682, commence filling of the battery(ies), using for example a battery electrolyte maintenance sub-system (BEMSS) as described herein with respect to FIG. 4. During filling, the proactive monitoring is maintained until at step 674 a normal liquid level is detected, at which point normal battery operation (discharge or recharging) commences.

Halting or abstaining filling operations as in step 684 can include non-operation of the pump, or operation of the pump with liquid bypassing all filling ports, and returning to a storage tank.

Activating alerts and/or pushing notifications as in step 686 can include an external indication for example in the form of a visual alarm or message directed to, for example, a centralized network operation center, and/or directly to the responsible technical field team or other responsible personnel; said indication can also include individual and discrete alerts/notifications for NLEL, ALEL, AEL and OFC. The indication can include an increased audible signal, blinking visual, specified text or voice alerts, or the like; said alert may be cleared when the electrolyte level is at a predetermined level or range corresponding to healthy battery operations, the AEL condition is resolved. Such alerts and/or notifications as in step 686 provide the technical field team or other personnel alerts and data about the exact environmental condition of the facility before attempting to enter, thus promoting high safety standards for personnel. Moreover, in certain implementations the integrated systems and methods herein automatically initiates calls or messages to the technical field team or other personnel for immediate attention and action under certain conditions; if the abnormalities or other detrimental conditions worsen, for example the electrolyte level of a given battery reaches minimum level and its associated abnormal low electrolyte level is activated plural times, an escalated call or message to the technical field team or other personnel and also management is initiated. In certain implementations Activating alerts and/or pushing notifications occur(s) when the internal battery electrolyte monitoring sub-system indicates a signal related to an excessively low electrolyte level, at which point the event push an essential notification to the centralized network operation center, for example demanding immediate attention by dispatching a technical field team or other personnel to begin inspection and if necessary remediation procedures.

In certain optional embodiments the integrated systems and methods herein also are in communication with a battery charging control system and breaker (e.g., including shut 116b shown in FIG. 1B). The breaker may be tripped if an unsafe condition worsens, for instance a battery voltage reading 1.75 volt per cell or specific gravity of 1.20. In such embodiments normal operation resumes when a normal reading have been established. In such implementations, batteries are interconnected through solenoid switches; a voltmeter sensor is connected to each battery and to the switch through the control sub-system. When a voltage or specific gravity abnormality is sensed, the control sub-system send a signal to the solenoid switch associated with the afflicted battery(ies) to change the connection to bypass those afflicted battery(ies) to prevent further current from being drawn from the now-isolated battery(ies). In certain implementations, voltage monitoring is conducted based on voltage from a bank, for example, with 24 batteries, a voltage level outside of a normal level range of about 48-54 volts would actual an alert and/or actuate a breaker to isolate the bank.

There are many examples of battery failures that may give rise to abnormal voltage conditions. One example is corrosion: corrosion of the battery terminals or internal connections can increase the internal resistance of the battery, leading to reduced voltage output. A second example is sulfation: if a battery is left in a discharged state for an extended period, lead sulfate crystals can form on the plates, which can harden and reduce the battery's capacity, leading to lower voltage levels. A third example is overcharging: charging a battery for too long can cause excessive heat and lead to the breakdown of internal components, lowering the battery capacity and voltage output. A fourth example is undercharging: repeated undercharging can leave a battery with a chronic deficit of charge, affecting its ability to hold and deliver full voltage. A fifth example is short-circuiting: an internal short circuit, due to the breakdown of separator material or other causes, can lead to a rapid decrease in voltage and may cause overheating or even a fire. Additional examples include damaged lead plates, electrolyte imbalances, temperature extremes, age/wear, and cell polarity reversal, among others.

With the integration of the electrolyte monitoring and maintenance sub-systems as described herein, another reason for abnormal voltage conditions is mitigated, that is, those concerning dry battery cells. When there is loss of electrolyte, often in the form of water loss due to evaporation or overcharging (which causes the water to decompose by electrolysis), increased internal resistance and decreased voltage ensue, as there is insufficient electrolyte to facilitate the charge/discharge reactions. The integrated electrolyte monitoring and maintenance sub-systems described herein prevent or minimize the likelihood of dry battery cells.

In addition, employing the systems and methods herein enable increased battery count within confined spaces. Further, the systems and methods herein enable intensified charging and discharging cycles. The systems and methods herein monitor and alert upon leakage of sulfuric acid that may remain unaddressed as is known in conventional battery filling protocols or battery electrolyte filling mechanisms, minimizing risk to equipment and any personnel who may need to enter the battery rooms. The systems and methods herein dynamically adapt to fluctuating electrolyte levels within individual batteries and provide proactive responses to unsuitable electrolyte levels and reactive responses to external leakage, in contrast to conventional battery filling protocols or battery electrolyte filling mechanisms that do not monitor external leakage. The systems and methods herein enable identification and selective filling individual batteries in need of electrolyte, in contrast to in contrast to conventional battery filling protocols or battery electrolyte filling mechanisms lacking this aspect which would leave battery rooms, particularly those situated in unmanned and remote locations, vulnerable to drying of the battery, irregular charging cycles and/or irregular discharging cycles, whilst also providing safety protocols preventing overfilling and preventing filling when external leakage is detected.

Further, the systems and methods herein integrate communication measures to promptly notify operations centers and provide detailed alerts through various channels, such as visual, auditory, and electronic communications, during situations where immediate attention and subsequent action are crucial for electrolyte management.

An exemplary configuration of a computing device of a control sub-system (either a main control sub-system, or another optional controller associated with the IBEMSS, BEMSS or EFMSS), and the methods discussed, above can be implemented is shown and described in connection with a controller computing device 706, as described in further detail below. The controller computing device 706 is programmed: to receive signals from one or more sensors monitoring an electrolyte level within each battery in the battery bank (e.g., via the IBEMSS described herein); to receive signals from one or more sensors monitoring overflow condition of each battery within each battery in the battery bank; to receive signals from one or more sensors monitoring leak conditions outside of the batteries of the battery bank; to process the received signals and to transmit instructions for safe automated battery filling operations based on the received signals as described herein, that is, when there is a NLEL, and there is an absence of ALEL, OFC and external leakage.

In a non-limiting example, the controller computing device 706 can be arranged with various hardware and software components that serve to enable operation of the system, including a processor 789, a memory 790, a communication interface 791 and a computer readable storage medium 792. The processor 789 serves to execute software instructions that can be loaded into the memory 790. The processor 789 can be a number of processors, a multi-processor core, or some other type of processor, depending on the particular implementation.

It is to be appreciated that the controller computing device 706 can be any computer such as a personal computer, minicomputer, workstation, mainframe, a dedicated controller such as a programmable logic controller, a tablet or smart phone, or a combination thereof. While the controller computing device 706 is shown, for illustration purposes, as a single computer unit, the system can comprise a distributed control system such as a group of computers which can be scaled depending on the processing load and database size. For example, one or more segments of an algorithm executable by a controller can be performed in separate computers, which in turn, can be in communication through one or more networks. In certain implementations all or certain of the components of the controller computing device 706 are a programmable logic controller, often referred to as a “plc” controller. An example of such a controller is an Arduino controller.

Preferably, the memory 790 and/or the storage 792 are accessible by the processor 789, thereby enabling the processor 789 to receive and execute instructions stored on the memory 790 and/or on the storage 792. The memory 790 can be, for example, a random access memory (RAM) or any other suitable volatile or non-volatile computer readable storage medium. In addition, the memory 790 can be fixed or removable. The storage 792 can take various forms, depending on the particular implementation. For example, the storage 792 can contain one or more components or devices such as a hard drive, a flash memory, a rewritable optical disk, a rewritable magnetic tape, or some combination of the above. The storage 792 also can be fixed or removable or remote such as cloud based data storage systems.

One or more software modules 793 are encoded in the storage 790 and/or in the memory 792. The software modules 793 can comprise computer readable media such as one or more software programs or applications having computer program code or a set of instructions executed in the processor 789. Such computer program code or instructions for carrying out operations and implementing aspects of the systems and methods disclosed herein can be written in any combination of one or more programming languages. The program code can execute entirely on controller computing device 706, as a stand-alone software package, partly on the controller computing device 706 and partly on a remote computer/device or entirely on such remote computers/devices. In the latter scenario, the remote computer systems can be connected to controller computing device 706 through any type of network, including a local area network (LAN) or a wide area network (WAN), or the connection can be made through an external computer (for example, through the Internet using an Internet Service Provider).

The term “computer-readable medium,” as used in this disclosure, means any tangible non-transitory storage medium that participates in providing data (for example, instructions) that can be read by a computer. Such a medium can take many forms, including non-volatile media and volatile media. Non-volatile media can include, for example, optical or magnetic disks and other persistent memory. Volatile media can include dynamic random access memory (DRAM). Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read. The computer-readable medium can include a “Cloud,” which includes a distribution of files across multiple (e.g., thousands of) memory caches on multiple (e.g., thousands of) computers. Various forms of computer readable media can be involved in carrying sequences of instructions to a computer. For example, sequences of instruction (i) can be delivered from a RAM to a processor, (ii) can be carried over a wireless transmission medium, and/or (iii) can be formatted according to numerous formats, standards or protocols, including, for example, WiFi, WiMAX, IEEE 802.11, DECT, 0G, 1G, 2G, 3G, 4G, or 5G cellular standards, Bluetooth, or the like.

The terms “transmission” or “transmit” as used in this disclosure, means the conveyance of signals via electricity, acoustic waves, light waves and other electromagnetic emissions, such as those generated with communications in the radio frequency (RF) or infrared (IR) spectra. Transmission media for such transmissions can include coaxial cables, copper wire and fiber optics, including the wires that comprise a system bus coupled to the processor.

Preferably, included among the software modules 793 are a database module 794, an input module 795, and a communication module 796, which are executed by processor 789. During execution of the software modules 793, the processor 789 is configured to perform various operations relating to the configuration of the controller computing device 706. More specifically, input module 795 configures the processor to receive operational/process data inputs from the sensors of the self-maintained battery system herein (including leak sensors, level sensors, overflow sensors, and optional voltage sensors. Database module 794 configures the processor to perform various data storage and data retrieval operations, for example, identification of the sensor(s) indicating an abnormal situation and therefore providing alerts as to the location of the abnormality. Communication module 796 configures the processor to communication with various components of the self-maintained battery system such as sending operational instructions including filling, halt of filling, and alerts/notifications. In addition, it should be noted that other information and/or data relevant to the operation of the present systems and methods can also be stored on the storage 792, for instance various control programs used in the operation of the controller computing device 706.

A database 797 can also be stored on the storage 792. Database 797 can contain and/or maintain various data items and elements that are utilized throughout the various operations of the system. Preferably, some or all of the stored information in the database 797 can be actionable data that is in a form or can be transformed into a form that enables the controller computing device 706 to undertake an action as needed by the program that implements any given application. The database 797 can also include device-specific applications that, when executed by the processor 789, configure the processor to communicate with one or more sub-systems of the self-maintained battery system. Similarly, the database can store other operational parameters that are specific to the controller computing device 706, the self-maintained battery system and or the sub-systems of the self-maintained battery system. The database can store the identification and location of each data-providing sensor and signal-receiving element (e.g., valve, solenoid) to facilitate prompt and accurate reactive and proactive responses.

It should be noted that although database 797 is depicted as being configured locally to the storage of the controller computing device 706, in certain implementations, database 797 and/or various of the data elements stored therein can be located remotely (such as on a remote server, not shown) and connected to the controller computing device 706 through a network in a manner known to those of ordinary skill in the art. The term “database,” as used in this disclosure, means any combination of software and/or hardware, including at least one application and/or at least one computer. The database can include a structured collection of records or data organized according to a database model, such as, for example, but not limited to at least one of a relational model, a hierarchical model, a network model or the like. The database can include a database management system application as is known in the art.

A communication interface 791 is also operatively connected to the processor 789 and can be any interface that enables communication between the controller computing device 706 and components of sub-systems of the self-maintained battery system herein. Preferably, the communication interface 791 includes, but is not limited to, a modem, a Network Interface Card (NIC), an integrated network interface, a radio frequency transmitter/receiver (e.g., Bluetooth, cellular, NFC), a satellite communication transmitter/receiver, an infrared port, a USB connection, and/or any other such interfaces for connecting controller computing device 706 to other computing devices and/or communication networks, such as private networks and the Internet. Such connections can include a wired connection or a wireless connection (e.g., using the IEEE 802.11 standard) though it should be understood that communication interface 791 can be practically any interface that enables communication to/from the controller computing device 706.

In some methods and systems consistent with the present disclosure, the self-maintained battery system and sub-systems therein further comprises regular intervals of diagnostic checking performed by the control sub-system through code executing on a processor housed therein. These diagnostic checks are performed to validate the functionality of the sensors, pumps, pump switches and valves.

It is to be understood that any structural and functional details disclosed herein are not to be interpreted as limiting the systems and methods, but rather are provided as a representative embodiment and/or arrangement for teaching one skilled in the art one or more ways to implement the methods.

It is to be further understood that like numerals in the drawings represent like elements through the several figures, and that not all components and/or steps described and illustrated with reference to the figures are required for all embodiments or arrangements.

Although process steps, method steps, algorithms, or the like, may be described in a sequential or a parallel order, such processes, methods and algorithms may be configured to work in alternate orders. In other words, any sequence or order of steps that may be described in a sequential order does not necessarily indicate a requirement that the steps be performed in that order; some steps may be performed simultaneously. Similarly, if a sequence or order of steps is described in a parallel (or simultaneous) order, such steps can be performed in a sequential order. The steps of the processes, methods or algorithms described herein may be performed in any order practical.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof.

Terms of orientation are used herein merely for purposes of convention and referencing, and are not to be construed as limiting. However, it is recognized these terms could be used with reference to a viewer. Accordingly, no limitations are implied or to be inferred.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

The subject matter described above is provided by way of illustration only and should not be construed as limiting. Various modifications and changes can be made to the subject matter described herein without following the example embodiments and applications illustrated and described, and without departing from the true spirit and scope of the invention encompassed by the present disclosure, which is defined by the set of recitations in the following claims and by structures and functions or steps which are equivalent to these recitations.

What is claimed is:

1. A method for self-maintenance of a battery bank, the battery bank comprising a plurality of lead-acid batteries, wherein each lead-acid battery comprises a jar containing electrolyte comprising sulfuric acid and water, and a pair of connection terminals, wherein the connection terminals of the plurality of batteries are operatively coupled to one another and operatively connected to a load, the method comprising:
providing a controller having a memory and a processor communicatively coupled to a battery electrolyte maintenance sub-system, the battery electrolyte maintenance sub-system including a battery filling system plug on each battery of the battery bank, a reservoir of water, fluid communication conduits between the reservoir of water and the battery filling system plug on each battery, and a controllable pump between the reservoir of water and the fluid communication conduits;
monitoring a surface below the batteries with one or more sensors communicatively coupled to the controller for an electrolyte leak condition, and transmitting to the controller a leak condition signal when fluid is detected on the surface; and
for each battery or a designated group of batteries, carrying out a routine of:
monitoring an electrolyte level with one or more level sensors associated with the battery and communicatively coupled to the controller, and (a) upon sensing a normal low electrolyte level (“NLEL”) corresponding to an electrolyte level within the battery that is within a predetermined range associated with normal electrolyte loss, transmitting a NLEL signal to the controller, or (b) upon sensing an abnormal low electrolyte level (‘ALEL”) corresponding to an electrolyte level within the battery that is below the predetermined range associated with normal electrolyte loss, transmitting a ALEL signal to the controller;
monitoring overflow condition with one or more overflow sensors associated with each battery and communicatively coupled to the controller, and upon sensing an electrolyte overflow condition (“OFC”) corresponding to fluid that is detected outside of the battery from one or more of the battery filling system plugs, transmitting an OFC signal to the controller; and
transmitting from the controller instructions to the controllable pump for carrying out responsive filling of the battery or the designated group of batteries with the battery electrolyte maintenance sub-system when
(a) the controller receives a NLEL signal, and
(b) the controller does not receive any one or more of
(i) an ALEL signal,
(ii) an OFC signal, or
(iii) a leak condition signal.

2. The method of claim 1, further comprising:
generating an external indicator that presents a condition of one or more batteries in the battery bank, the conditions including one or more of:
presence or absence of a leak condition signal associated with a designated battery corresponding to fluid being detected on the surface;
presence or absence of an OFC signal associated with a designated battery corresponding to fluid being detected outside of the battery from one or more of the battery filling system plugs;
presence or absence of a NLEL signal associated with a designated battery corresponding to an electrolyte level within the battery that is within the predetermined range associated with normal electrolyte loss;
presence or absence of an ALEL signal associated with a designated battery corresponding to an electrolyte level within the battery that is below the predetermined range associated with normal electrolyte loss; or
state of responsive filling operations.

3. The method of claim 2, wherein the external indicator comprises an increased volume audible alert, a distinctive audible alert, a voice alert, a blinking visual alerts, a text message alert, an icon image message alert, a real-time camera image alert, a voice alert, or a combination of one of the forgoing alerts.

4. The method of claim 1, wherein the controller is programmed with scheduled filling instructions, further comprising:
transmitting from the controller instructions to the controllable pump for carrying out scheduled filling of the designated battery in the battery bank with the battery electrolyte maintenance sub-system when the controller does not receive any one of
(i) an ALEL signal from the designated battery,
(ii) an OFC signal from the designated battery, or
(iii) a leak condition signal.

5. The method of claim 4, wherein scheduled filling operations coincide with one or more charging cycles of the designated battery.

6. The method of claim 4, further comprising:
generating an external indicator that presents a condition of one or more batteries in the battery bank, the conditions including one or more of:
presence or absence of a leak condition signal associated with a designated battery corresponding to fluid being detected on the surface;
presence or absence of an OFC signal associated with a designated battery corresponding to fluid being detected outside of the battery from one or more of the battery filling system plugs;
presence or absence of a NLEL signal associated with a designated battery corresponding to an electrolyte level within the battery that is within the predetermined range associated with normal electrolyte loss;
presence or absence of an ALEL signal associated with a designated battery corresponding to an electrolyte level within the battery that is below the predetermined range associated with normal electrolyte loss; or
state of filling operations and including whether a filling operation is a responsive filling operation or a scheduled filling operation.

7. The method of claim 6, wherein the external indicator comprises an increased volume audible alert, a distinctive audible alert, a voice alert, a blinking visual alerts, a text message alert, an icon image message alert, a real-time camera image alert, a voice alert, or a combination of one of the forgoing alerts.

8. The method of claim 1, wherein, during periods of responsive filling, monitoring of the electrolyte level within the designated battery continues, and wherein responsive filling ends when a predetermined normal electrolyte level is reached.

9. The method of claim 1, wherein the battery electrolyte maintenance sub-system further comprises controllable valves associated with the batteries in the battery bank, and wherein responsive filling includes opening selected controllable valves to open fluid communication between the controllable pump and the battery filling system plug on each battery.

10. The method of claim 1, wherein the routine is carried out upon the designated group of batteries.

11. A battery system integrating electrolyte monitoring and maintenance comprising:
a battery bank comprising a plurality of lead-acid batteries, wherein each lead-acid battery comprises a jar containing electrolyte comprising sulfuric acid and water, and a pair of connection terminals, wherein the connection terminals of the plurality of batteries are operatively coupled to one another and operatively connected to a load;
a battery electrolyte maintenance sub-system including a battery filling system plug on each battery of the battery bank, a reservoir of water, fluid communication conduits between the reservoir of water and the battery filling system plug on each battery, and a controllable pump between the reservoir of water and the fluid communication conduits;
an external fluid monitoring sub-system including a plurality of leak sensors positioned to detect liquid leakage from one or more battery jars;
an internal battery electrolyte monitoring sub-system including, in each battery, one or more level sensors operable to determine a normal low electrolyte level and an abnormal low electrolyte level;
an overflow sensor on each battery operable to determine presence of an overflow condition;
a controller having a memory and processor that is communicatively connected to the battery electrolyte maintenance sub-system, the external fluid monitoring sub-system, the internal battery electrolyte monitoring sub-system, and the overflow sensor, wherein the controller is programmed to execute processes for
monitoring an electrolyte level with the one or more level sensors associated with each battery and communicatively coupled to the controller, and (a) upon sensing a normal low electrolyte level (“NLEL”) corresponding to an electrolyte level within the battery that is within a predetermined range associated with normal electrolyte loss, transmitting a NLEL signal to the controller, or (b) upon sensing an abnormal low electrolyte level (‘ALEL”) corresponding to an electrolyte level within the battery that is below the predetermined range associated with normal electrolyte loss, transmitting a ALEL signal to the controller;
monitoring overflow condition with the one or more overflow sensors associated with each battery and communicatively coupled to the controller; and upon sensing an electrolyte overflow condition (“OFC”) corresponding to fluid that is detected outside of the battery from one or more of the battery filling system plugs, transmitting an OFC signal to the controller; and
transmitting from the controller instructions to the controllable pump for carrying out responsive filling of the battery or the designated group of batteries with the battery electrolyte maintenance sub-system when
(c) the controller receives a NLEL signal, and
(d) the controller does not receive any one or more of
(i) an ALEL signal,
(ii) an OFC signal, or
(iii) a leak condition signal.

12. The battery system of claim 11, wherein the overflow sensors are part of the battery electrolyte maintenance sub-system, the external fluid monitoring sub-system or the internal battery electrolyte monitoring sub-system.

13. The battery system of claim 11, wherein the battery filling system plug on each battery comprises a sensor adapted to determine overflow, wherein the overflow sensor on each battery is a redundant sensor.

14. The battery system of claim 11, wherein the one or more level sensors operable to determine a normal low electrolyte level and an abnormal low electrolyte level are internal to the battery jar.

15. The battery system of claim 11, wherein the one or more level sensors operable to determine a normal low electrolyte level and an abnormal low electrolyte level are external to the battery jar.

16. The battery system of claim 11, wherein batteries are supported on a surface elevated from the ground, and wherein and the leak sensors are provided on the elevated surface, on the ground, or on both the ground and the elevated surface.
